(19) United States
(12) Patent Application Publication
(10) Pub. No.: US 2025/0242613 A1
(43) Pub. Date: Jul. 31, 2025

(54) SHEET CONVEYING DEVICE CAPABLE OF ADJUSTING ATTITUDE OF CORRECTING PORTION THAT CORRECTS CONVEYANCE ATTITUDE OF SHEET, AND IMAGE FORMING APPARATUS

(71) Applicant: KYOCERA Document Solutions Inc., Osaka (JP)

(72) Inventor: Takenori Yamamoto, Osaka (JP)

(21) Appl. No.: 19/036,549

(22) Filed: Jan. 24, 2025

(30) Foreign Application Priority Data
Jan. 26, 2024 (JP) 2024-009862

(51) Int. Cl. B41J 13/30; B41J 11/00; B41J 13/03; B41J 13/076

(52) U.S. Cl. CPC B41J 13/30; B41J 11/0095; B41J 13/03; B41J 13/076

(57) ABSTRACT

A sheet conveying device includes a first conveying portion, a correcting portion, a second conveying portion, and an angle changing portion. The first conveying portion conveys a sheet. The correcting portion is provided on an upstream side of the first conveying portion in a conveyance direction of the sheet by the first conveying portion. The correcting portion has an opposed surface that is opposed to a side end of the sheet in a first direction orthogonal to the conveyance direction. The second conveying portion is provided on an upstream side of the correcting portion in the conveyance direction. The second conveying portion conveys the sheet in a second direction toward the opposed surface. The angle changing portion changes an inclination angle of the opposed surface with respect to the conveyance direction.

### INCORPORATION BY REFERENCE

This application is based upon and claims the benefit of priority from the corresponding Japanese Patent Application No. 2024-009862 filed on Jan. 26, 2024, the entire contents of which are incorporated herein by reference.

### BACKGROUND

This disclosure relates to a sheet conveying device and an image forming apparatus.

An image forming apparatus including a correcting portion that corrects the conveyance attitude of a sheet to be conveyed to an image forming portion such as an ink jet head has been known. In addition, an image forming apparatus in which the integral attachment of the correcting portion to a conveying portion that conveys the sheet below the ink jet head makes it possible to prevent the attitude of the correcting portion from being inclined with respect to the conveyance direction of the sheet by the conveying portion has been known as the related art.

### SUMMARY

A sheet conveying device according to an aspect of this disclosure includes a first conveying portion, a correcting portion, a second conveying portion, and an angle changing portion. The first conveying portion conveys a sheet. The correcting portion is provided on an upstream side of the first conveying portion in a conveyance direction of the sheet by the first conveying portion. The correcting portion has an opposed surface that is opposed to a side end of the sheet in a first direction orthogonal to the conveyance direction. The second conveying portion is provided on an upstream side of the correcting portion in the conveyance direction. The second conveying portion conveys the sheet in a second direction toward the opposed surface. The angle changing portion changes an inclination angle of the opposed surface with respect to the conveyance direction.

An image forming apparatus according to another aspect of this disclosure includes the sheet conveying device and an image forming portion. The image forming portion forms an image on the sheet conveyed by the first conveying portion.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a cross-sectional view of a configuration of an image forming apparatus according to an embodiment of this disclosure.

FIG. 2 is a plan view of configurations of an image forming portion, a conveying unit, and a line sensor in the image forming apparatus according to the embodiment of this disclosure.

FIG. 3 is a plan view of a configuration of an attitude correcting portion in the image forming apparatus according to the embodiment of this disclosure.

FIG. 4 is a block diagram showing a system configuration of the image forming apparatus according to the embodiment of this disclosure.

FIG. 5 is a flowchart showing an example of an inclination angle adjustment process that is executed by the image forming apparatus according to the embodiment of this disclosure.

FIG. 6 is a diagram showing an example of shape data acquired by the image forming apparatus according to the embodiment of this disclosure.

### DETAILED DESCRIPTION

Hereinafter, an embodiment of this disclosure will be described with reference to the appended drawings. It is to be noted that the following embodiment is a specific example of this disclosure and does not limit the technical scope of this disclosure.

### [Configuration of Image Forming Apparatus 100]

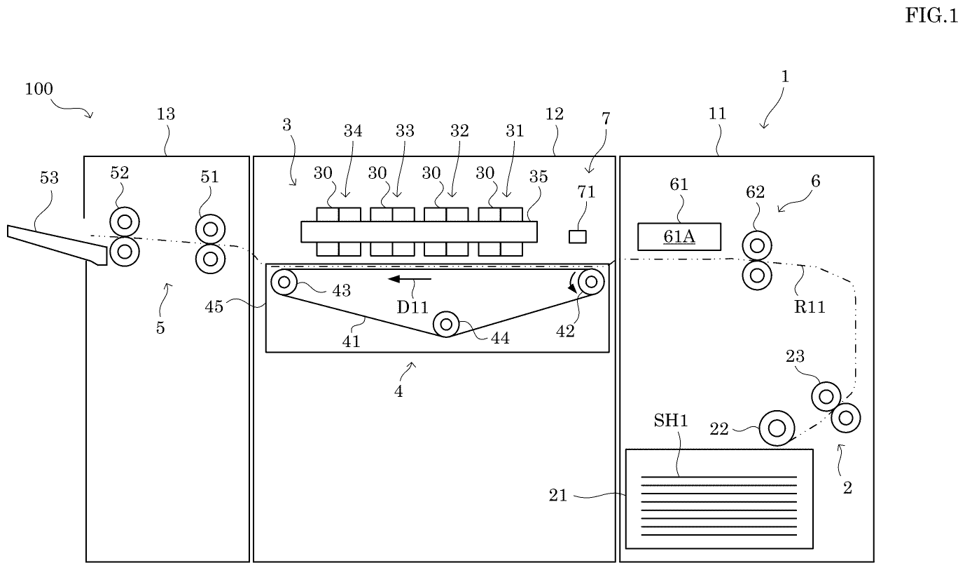

First, the configuration of an image forming apparatus 100 according to an embodiment of this disclosure will be described with reference to FIGS. 1 to 4. It is to be noted that FIG. 1 shows a sheet conveyance route R11 by a two-dot chain line.

The image forming apparatus 100 is a printer capable of forming an image on a sheet SH1 (see FIG. 1) in an ink-jet method. It is to be noted that this disclosure may be applied to a facsimile apparatus, a copier, or a multifunction peripheral capable of forming an image on the sheet SH1 in an ink-jet method. In addition, this disclosure may be applied to an image forming apparatus capable of forming an image on the sheet SH1 in a method different from the ink-jet method such as electrophotography.

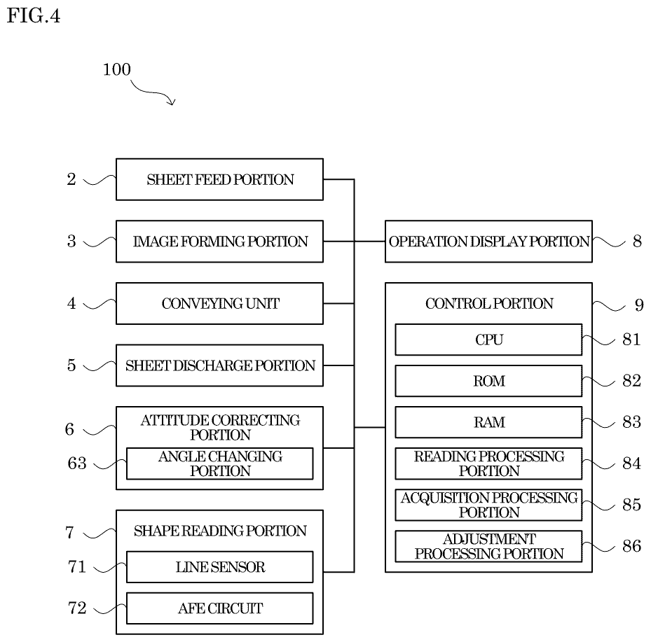

As shown in FIG. 1, the image forming apparatus 100 includes a housing 1, a sheet feed portion 2, an image forming portion 3, a conveying unit 4, a sheet discharge portion 5, an attitude correcting portion 6, and a shape reading portion 7. In addition, the image forming apparatus 100 includes an operation display portion 8 and a control portion 9 shown in FIG. 4. A device including the conveying unit 4 and the attitude correcting portion 6 is an example of a sheet conveying device according to this disclosure.

The housing 1 houses the respective components of the image forming apparatus 100. As shown in FIG. 1, the housing 1 includes a first housing 11, a second housing 12, and a third housing 13 that are connected. As shown in FIG. 1, the first housing 11 houses the sheet feed portion 2 and the attitude correcting portion 6. As shown in FIG. 1, the second housing 12 houses the image forming portion 3, the conveying unit 4, and the shape reading portion 7. As shown in FIG. 1, the third housing 13 houses the sheet discharge portion 5.

The sheet feed portion 2 supplies the sheet SH1 to the second housing 12. As shown in FIG. 1, the sheet feed portion 2 includes a sheet feed cassette 21, a pickup roller 22, and sheet feed rollers 23. The sheet feed cassette 21 stores the sheet SH1. The sheet SH1 stored in the sheet feed cassette 21 of the first housing 11 is conveyed inside the housing 1 along the sheet conveyance route R11 (see FIG. 1) that reaches a sheet discharge tray 53 (see FIG. 1) through the first housing 11, the second housing 12, and the third housing 13. The pickup roller 22 picks up the uppermost sheet SH1 of the bundle of sheets SH1 stored in the sheet feed cassette 21 and sends the sheet SH1 to the sheet conveyance route R11. The sheet feed rollers 23 convey the sheet SH1 along the sheet conveyance route R11.

The image forming portion 3 forms an image on the sheet SH1 conveyed by the conveying unit 4. As shown in FIG. 1, the image forming portion 3 includes line heads 31 to 34 and a head frame 35.

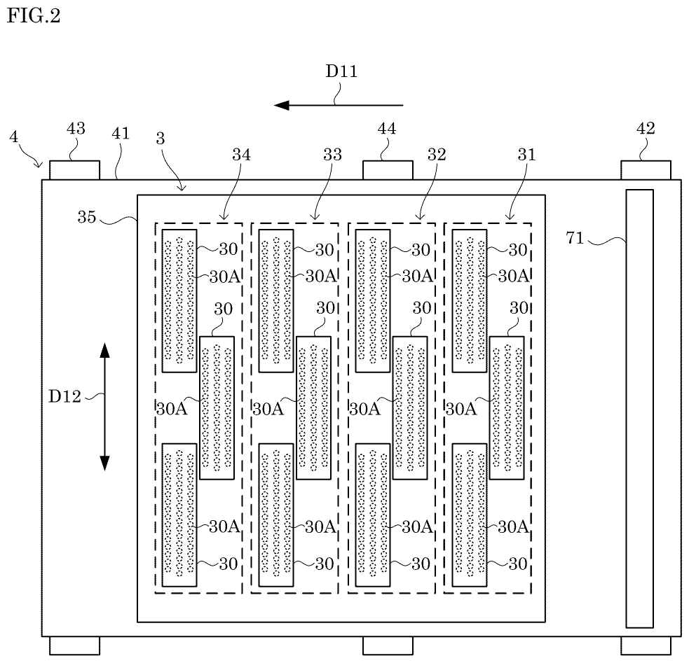

As shown in FIG. 2, each of the line heads 31 to 34 is long in a width direction D12 orthogonal to a conveyance direction D11 of the sheet SH1 by the conveying unit 4. Specifically, each of the line heads 31 to 34 has the length corresponding to the width of the sheet SH1 having the maximum size in the width direction D12 among the sheets SH1 storable in the sheet feed cassette 21. The respective line heads 31 to 34 are provided side by side at even intervals along the conveyance direction D11.

As shown in FIG. 2, each of the line heads 31 to 34 includes a plurality of recording heads 30. Each of the recording head 30 jets ink to the sheet SH1 conveyed by the conveying unit 4. Each of the recording heads 30 provided to the line head 31 jets black ink. Each of the recording heads 30 provided to the line head 32 jets cyan ink. Each of the recording heads 30 provided to the line head 33 jets magenta ink. Each of the recording heads 30 provided to the line head 34 jets yellow ink.

Each of the recording heads 30 includes a plurality of nozzles 30A (see FIG. 2) that each jets ink. The plurality of nozzles 30A is provided on the surface of the recording head 30 opposed to the sheet SH1 conveyed by the conveying unit 4.

In addition, each of the recording heads 30 includes a pressurizing chamber (not shown), a piezoelectric element (not shown), and an individual channel (not shown) corresponding to each of the nozzles 30A. The pressurizing chamber communicates with the nozzle 30A and stores ink. The piezoelectric element causes the nozzle 30A to jet ink in response to the application of a drive voltage defined in advance. The individual channel is an ink channel provided between the pressurizing chamber and a common channel (not shown) common to the plurality of nozzles 30A. A plurality of the individual channels corresponding to the plurality of nozzles 30A is connected to the common channel. The common channel is connected to an ink supply portion (not shown) that supplies ink to each of the pressurizing chambers.

As shown in FIG. 2, the line head 31 includes the three recording heads 30 having a staggered array along the width direction D12. In addition, each of the other line heads 32 to 34 also includes the three recording heads 30 having a staggered array along the width direction D12 as with the line head 31.

The head frame 35 supports the line heads 31 to 34. The head frame 35 is supported by the second housing 12. It is to be noted that the number of line heads provided to the image forming portion 3 does not have to be 4. In addition, the number of recording heads 30 provided to each of the line heads 31 to 34 does not have to be 3.

As shown in FIG. 1, the conveying unit 4 is disposed below the line heads 31 to 34. The conveying unit 4 conveys the sheet SH1 while opposing the sheet to the recording heads 30. For example, whenever the recording heads 30 each jet ink, the conveying unit 4 conveys the sheet SH1 by the amount of conveyance defined in advance. In addition, the conveying unit 4 stops conveying the sheet SH1 while the recording heads 30 are each jetting ink. As shown in FIG. 1, the conveying unit 4 includes a conveying belt 41 on which the sheet SH1 is placed, a first stretching roller 42, a second stretching roller 43, a third stretching roller 44, and a conveyance frame 45. The first stretching roller 42, the second stretching roller 43, and the third stretching roller 44 stretch the conveying belt 41. The conveyance frame 45 supports them. It is to be noted that the gap between the conveying belt 41 and the recording heads 30 is adjusted to cause the gap between the surface of the sheet SH1 and the recording heads 30 to have a predetermined distance (e.g., 1 mm) at the time of image formation. The conveying unit 4 is an example of a first conveying portion according to this disclosure.

The first stretching roller 42 is driven to rotate by rotational driving force supplied from an unillustrated motor. This rotates the conveying belt 41 in the direction that allows the sheet SH1 to be conveyed in the conveyance direction D11 (see FIG. 1). It is to be noted that the conveying unit 4 is provided with a suction unit (not shown) or the like to cause the conveying belt 41 to adsorb the sheet SH1. The suction unit takes in air from a large number of through holes formed in the conveying belt 41.

The sheet discharge portion 5 discharges the sheet SH1 having an image formed thereon to the outside of the third housing 13. As shown in FIG. 1, the sheet discharge portion 5 includes first sheet discharge rollers 51, second sheet discharge rollers 52, and the sheet discharge tray 53. The first sheet discharge rollers 51 and the second sheet discharge rollers 52 convey the sheet SH1 having an image formed thereon along the sheet conveyance route R11. The sheet discharge tray 53 is provided on the outside surface of the third housing 13. The sheet SH1 having an image formed thereon is discharged to the sheet discharge tray 53. It is to be noted that the third housing 13 is also provided with a drying device (not shown) that dries the sheet SH1 having an image formed thereon and conveyed along the sheet conveyance route R11.

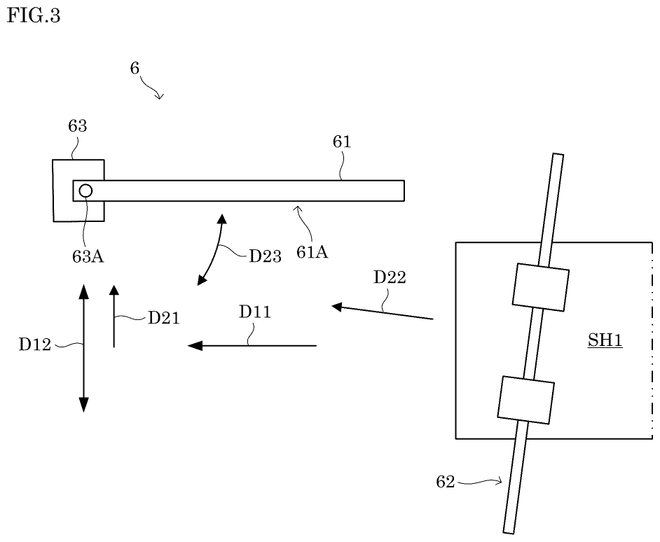

The attitude correcting portion 6 corrects the conveyance attitude of the sheet SH1 to be conveyed to the image forming portion 3. As shown in FIGS. 1 and 3, the attitude correcting portion 6 includes a correcting portion 61, conveying rollers 62, and an angle changing portion 63.

As shown in FIG. 1, the correcting portion 61 is provided on the upstream side of the conveying unit 4 in the conveyance direction D11 of the sheet SH1 by the conveying unit 4. The correcting portion 61 has an opposed surface 61A (see FIGS. 1 and 3) that is opposed to the side end of the sheet SH1 in a first direction D21 (see FIG. 3) orthogonal to the conveyance direction D11. For example, the correcting portion 61 is a member shaped like a flat plate that is long along the conveyance direction D11. The correcting portion 61 is disposed at the end of the sheet conveyance route R11 in the first direction D21. In addition, the correcting portion 61 is disposed such that the opposed surface 61A is parallel with the conveyance direction D11.

As shown in FIG. 1, the conveying rollers 62 are provided on the upstream side of the correcting portion 61 in the conveyance direction D11. The conveying rollers 62 convey the sheet SH1 in a second direction D22 (see FIG. 3) toward the opposed surface 61A. Specifically, as shown in FIG. 3, the conveying rollers 62 are each disposed in an attitude inclined with respect to the conveyance direction D11. In other words, the conveying rollers 62 are each disposed to have a rotation shaft in an attitude inclined with respect to the width direction D12. As shown in FIG. 3, the second direction D22 is a direction inclined with respect to the conveyance direction D11. Each of the conveying rollers 62 is an example of a second conveying portion according to this disclosure.

When the sheet SH1 is conveyed in the second direction D22 by the conveying rollers 62, the side end of the sheet SH1 in the first direction D21 comes into contact with the opposed surface 61A of the correcting portion 61. This corrects the conveyance attitude of the sheet SH1.

Incidentally, an image forming apparatus including a registration roller instead of the correcting portion 61 has been known. In addition, an image forming apparatus in which the integral attachment of the registration roller to the conveying unit 4 makes it possible to prevent the attitude of the registration roller from being inclined with respect to the conveyance direction D11 has been known as the related art.

The image forming apparatus according to the related art described above does not, however, make it possible to prevent the attitude of the registration roller from being inclined with respect to the conveyance direction D11 in a case where it is not possible to integrally attach the registration roller to the conveying unit 4. For example, in a case where the conveying unit 4 is disposed in the second housing 12 and the registration roller is disposed in the first housing 11, it is not possible to integrally attach the registration roller to the conveying unit 4.

In contrast, the image forming apparatus 100 according to the embodiment of this disclosure makes it possible to prevent the attitude of the correcting portion 61 from being inclined with respect to the conveyance direction D11 as described below.

The angle changing portion 63 changes the inclination angle of the opposed surface 61A with respect to the conveyance direction D11.

For example, the angle changing portion 63 is a stepping motor including a drive shaft 63A (see FIG. 3) that is long in the direction orthogonal to the conveyance direction D11 and the width direction D12.

The correcting portion 61 is attached to the drive shaft 63A such that the correcting portion 61 is allowed to rotate integrally with the drive shaft 63A. Specifically, as shown in FIG. 3, the correcting portion 61 is attached to the drive shaft 63A such that the correcting portion 61 extends from the drive shaft 63A in the direction orthogonal to the extending direction of the drive shaft 63A. In addition, the correcting portion 61 is attached to the drive shaft 63A such that the opposed surface 61A crosses a rotation direction D23 (see FIG. 3) of the drive shaft 63A.

The shape reading portion 7 reads the shape of the sheet SH1 conveyed along the sheet conveyance route R11.

As shown in FIG. 4, the shape reading portion 7 includes a line sensor 71 and an analog front-end (AFE) circuit 72.

As shown in FIG. 1, the line sensor 71 is provided on the upstream side of the image forming portion 3 in the sheet conveyance route R11 in the conveyance direction D11 and the downstream side of the attitude correcting portion 6 in the conveyance direction D11. In addition, the line sensor 71 is provided above the conveying belt 41. In addition, as shown in FIG. 2, the line sensor 71 is provided to be long along the width direction D12. The line sensor 71 images the sheet SH1 conveyed along the sheet conveyance route R11.

For example, the line sensor 71 is a contact image sensor (CIS). The line sensor 71 includes a plurality of imaging elements disposed side by side in the width direction D12 (see FIG. 2). Each of the imaging elements includes a light emitting portion and a light receiving portion. The light emitting portion emits light to the conveying belt 41. The light receiving portion is provided such that the light receiving portion is allowed to receive light emitted from the light emitting portion and reflected by the conveying belt 41 or the conveyed sheet SH1. The light receiving portion outputs an analog electrical signal corresponding to the amount of received light. The line sensor 71 images the sheet SH1 conveyed along the sheet conveyance route R11 in an imaging cycle defined in advance. Specifically, the line sensor 71 outputs an analog electrical signal corresponding to an image of an imaging target (the sheet SH1 and the conveying belt 41) opposed to the line sensor 71 in the imaging cycle. It is to be noted that the outer peripheral surface of the conveying belt 41 is colored to have a color like black that reduces the reflection of light emitted from the light emitting portion more than the base color (white) of the sheet SH1 does.

The AFE circuit 72 is an electronic circuit that executes a process defined in advance on an analog electrical signal output from the line sensor 71. Specifically, the AFE circuit 72 includes a signal converting portion that converts an analog electrical signal output from the line sensor 71 into a digital electrical signal (image data). In addition, the AFE circuit 72 includes a binarize portion that executes a binarize process on image data output from the signal converting portion. The binarize process is a process of binarizing each of the pixels included in image data output from the signal converting portion as a value indicating the presence or absence of the sheet SH1. The image data (referred to as “line data” below) binarized by the binarize portion is input to the control portion 9.

The operation display portion 8 is a user interface of the image forming apparatus 100. The operation display portion 8 includes a display portion and an operation portion. The display portion displays various kinds of information in response to a control instruction from the control portion 9. For example, the display portion is a flat-panel display such as a liquid-crystal display. The operation portion inputs various kinds of information to the control portion 9 in response to an operation of a user. For example, the operation portion includes an operation key and a touch panel.

The control portion 9 integrally controls the image forming apparatus 100. As shown in FIG. 4, the control portion 9 includes a CPU 81, a ROM 82, and a RAM 83. The CPU 81 is a processor that executes various calculation processes. The ROM 82 is a non-volatile storage device in which information such as a control program or the like for causing the CPU 81 to execute various processes is stored in advance. The RAM 83 is a volatile or non-volatile storage device that is used as a temporary storage memory (work area) for various processes which are executed by the CPU 81. The CPU 81 integrally controls the image forming apparatus 100 by executing various control programs stored in the ROM 82 in advance.

As shown in FIG. 4, the control portion 9 includes a reading processing portion 84, an acquisition processing portion 85, and an adjustment processing portion 86. Specifically, the CPU 81 of the control portion 9 executes the control programs stored in the ROM 82 to function as the reading processing portion 84, the acquisition processing portion 85, and the adjustment processing portion 86. It is to be noted that the reading processing portion 84, the acquisition processing portion 85, and the adjustment processing portion 86 may be achieved by an electronic circuit.

The reading processing portion 84 reads the outer shape of the sheet SH1 that has passed through the correcting portion 61.

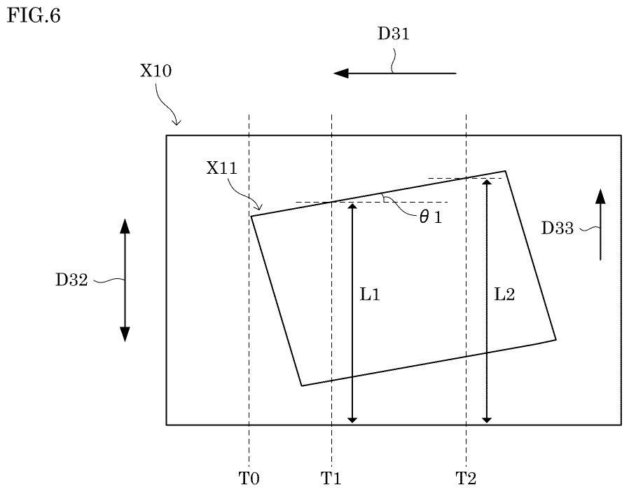

For example, the reading processing portion 84 acquires shape data X10 (see FIG. 6) by using the line sensor 71. The shape data X10 indicates the shape of the sheet SH1 that has passed through the correcting portion 61.

For example, in a case where the front end of the sheet SH1 is sensed by an unillustrated sheet sensor provided on the upstream side of the line sensor 71 in the sheet conveyance route R11 (see FIG. 1) in the conveyance direction D11, the reading processing portion 84 causes the shape reading portion 7 to start to read the shape of the sheet SH1. This outputs the line data from the shape reading portion 7 in the imaging cycle. In addition, in a case where a specific time defined in advance passes after the back end of the sheet SH1 is sensed by the sheet sensor, the reading processing portion 84 causes the shape reading portion 7 to end reading the shape of the sheet SH1. The specific time is set such that the shape reading portion 7 ends reading the shape of the sheet SH1 after the back end of the sheet SH1 passes through the position opposed to the line sensor 71. The reading processing portion 84 then acquires each piece of the line data output from the shape reading portion 7 in a period in which the shape reading portion 7 is reading the shape of the sheet SH1. That is, the shape data X10 is data including a plurality of pieces of the line data output from the shape reading portion 7 in a period in which the shape reading portion 7 is reading the shape of the sheet SH1.

FIG. 6 shows an example of the shape data X10. The shape data X10 shown in FIG. 6 is the shape data X10 acquired by the reading processing portion 84 in a case where the attitude of the correcting portion 61 is inclined with respect to the conveyance direction D11. The shape data X10 includes a sheet region X11 indicating the sheet SH1. The sheet region X11 is a region formed by using a pixel indicating the presence of the sheet SH1. The outside of the sheet region X11 in the shape data X10 is formed by using a pixel indicating the absence of the sheet SH1. It is to be noted that a third direction D31 shown in FIG. 6 is a direction corresponding to the conveyance direction D11. In addition, a fourth direction D32 shown in FIG. 6 is a direction corresponding to the width direction D12 (see FIG. 2). In addition, a fifth direction D33 shown in FIG. 6 is a direction corresponding to the first direction D21 (see FIG. 3).

The acquisition processing portion 85 acquires the inclination angle of the side end of the sheet SH1 that has passed through the correcting portion 61 with respect to the conveyance direction D11 on the basis of a result of reading by the reading processing portion 84.

For example, the acquisition processing portion 85 acquires the inclination angle of the side end of the sheet SH1 that has passed through the correcting portion 61 in the first direction D21 (see FIG. 3) with respect to the conveyance direction D11 on the basis of a result of reading by the reading processing portion 84.

Specifically, the acquisition processing portion 85 acquires an inclination angle θ1 (see FIG. 6) of the end of the sheet region X11 in the fifth direction D33 with respect to the third direction D31 as the inclination angle of the side end of the sheet SH1 that has passed through the correcting portion 61 in the first direction D21 (see FIG. 3) with respect to the conveyance direction D11. The sheet region X11 is included in the shape data X10 (see FIG. 6) acquired by the reading processing portion 84.

For example, whenever the reading processing portion 84 acquires the line data, the acquisition processing portion 85 determines whether or not the acquired line data includes a pixel indicating the presence of the sheet SH1. In addition, the acquisition processing portion 85 measures the time elapsed since a timing TO (see FIG. 6) at which the acquisition processing portion 85 first determines that the line data includes a pixel indicating the presence of the sheet SH1. In addition, the acquisition processing portion 85 acquires distance L1 (see FIG. 6) (the number of pixels) from the end of the line data opposite to the fifth direction D33 to the end of the sheet region X11 in the fifth direction D33. The line data is acquired at a timing T1 (see FIG. 6) at which the time elapsed since the timing TO reaches first time defined in advance. In addition, the acquisition processing portion 85 acquires distance L2 (see FIG. 6) (the number of pixels) from the end of the line data opposite to the fifth direction D33 to the end of the sheet region X11 in the fifth direction D33. The line data is acquired at a timing T2 (see FIG. 6) at which the time elapsed since the timing TO reaches second time longer than the first time. The acquisition processing portion 85 then calculates the inclination angle θ1 on the basis of the difference between the distance L2 and the distance L1 and the distance (the number of pixels) corresponding to the time from the timing T1 to the timing T2.

The adjustment processing portion 86 adjusts the inclination angle of the opposed surface 61A with respect to the conveyance direction D11 on the basis of a result of acquisition by the acquisition processing portion 85.

For example, the adjustment processing portion 86 converts the inclination angle acquired by the acquisition processing portion 85 into the drive amount of the angle changing portion 63 by using table data defined in advance. The table data is data in which the correspondence between the inclination angle acquired by the acquisition processing portion 85 and the drive amount of the angle changing portion 63 is defined to allow the inclination angle of the opposed surface 61A with respect to the conveyance direction D11 to be zero. The table data is stored in a non-volatile storage device such as the ROM 82 in advance.

The adjustment processing portion 86 then controls the driving of the angle changing portion 63 on the basis of the drive amount of the angle changing portion 63 acquired by using the table data.

### [Inclination Angle Adjustment Process]

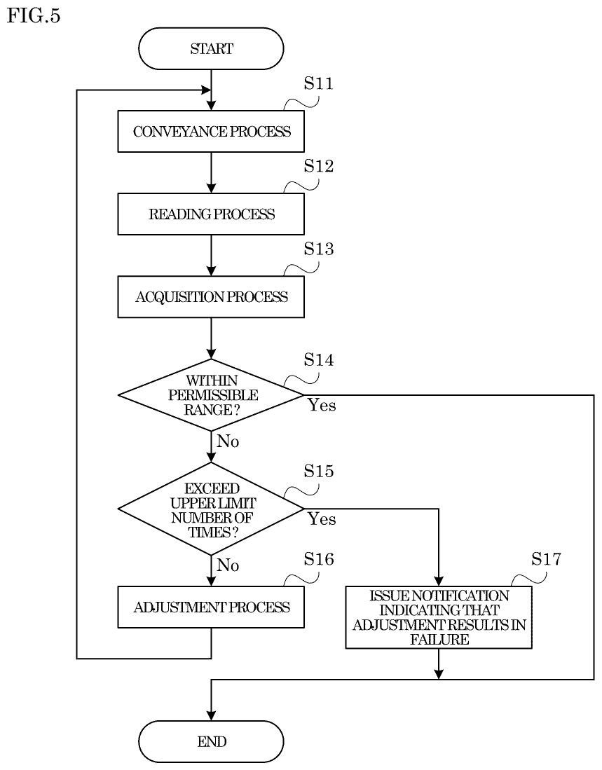

Examples of procedures of an inclination angle adjustment process that is executed by the control portion 9 in the image forming apparatus 100 will be described below with reference to FIG. 5. Here, steps S11, S12, . . . denote the numbers of processing procedures (steps) that are executed by the control portion 9. It is to be noted that the inclination angle adjustment process is executed in a case where an instruction to execute the inclination angle adjustment process is input through an operation of a user on the operation display portion 8.

### <Step S11>

First, in step S11, the control portion 9 executes a conveyance process of conveying the sheet SH1 along the sheet conveyance route R11.

### <Step S12>

In step S12, the control portion 9 executes a reading process of reading the outer shape of the sheet SH1 that has passed through the correcting portion 61. The process of step S12 is executed by the reading processing portion 84 of the control portion 9.

Specifically, the control portion 9 acquires shape data X10 (see FIG. 6) by using the line sensor 71. The shape data X10 indicates the shape of the sheet SH1 that has passed through the correcting portion 61.

### <Step S13>

In step S13, the control portion 9 executes an acquisition process of acquiring the inclination angle of the side end of the sheet SH1 that has passed through the correcting portion 61 with respect to the conveyance direction D11 on the basis of a result of reading through the reading process. The process of step S13 is executed by the acquisition processing portion 85 of the control portion 9.

Specifically, the control portion 9 acquires an inclination angle θ1 (see FIG. 6) of the end of the sheet region X11 in the fifth direction D33 with respect to the third direction D31 as the inclination angle of the side end of the sheet SH1 that has passed through the correcting portion 61 in the first direction D21 (see FIG. 3) with respect to the conveyance direction D11. The sheet region X11 is included in the shape data X10 (see FIG. 6) acquired through the reading process.

### <Step S14>

In step S14, the control portion 9 determines whether or not the inclination angle acquired through the acquisition process is within a permissible range defined in advance. For example, the permissible range is a range of plus or minus five degrees around 0 degrees. It is to be noted that the permissible range may be any range around 0 degrees.

Here, when the control portion 9 determines that the inclination angle acquired through the acquisition process is within the permissible range (Yes in S14), the control portion 9 ends the inclination angle adjustment process. In addition, if the inclination angle acquired through the acquisition process is not within the permissible range (No in S14), the control portion 9 causes the process to transition to step S15.

### <Step S15>

In step S15, the control portion 9 determines whether or not the number of times the process of step S16 is executed exceeds the upper limit number of times defined in advance. For example, the upper limit number of times is three times. It is to be noted that the upper limit number of times may be any number of times.

Here, when the control portion 9 determines that the number of times the process of step S16 is executed exceeds the upper limit number of times (Yes in S15), the control portion 9 causes the process to transition to step S17. In addition, if the number of times the process of step S16 is executed does not exceed the upper limit number of times (No in S15), the control portion 9 causes the process to transition to step S16.

### <Step S16>

In step S16, the control portion 9 executes an adjustment process of adjusting the inclination angle of the opposed surface 61A with respect to the conveyance direction D11 on the basis of a result of acquisition through the acquisition process. The process of step S16 is executed by the adjustment processing portion 86 of the control portion 9.

For example, the control portion 9 converts the inclination angle acquired through the acquisition process into the drive amount of the angle changing portion 63 by using the table data. The control portion 9 then controls the driving of the angle changing portion 63 on the basis of the drive amount of the angle changing portion 63 acquired by using the table data.

### <Step S17>

In step S17, the control portion 9 notifies a user that the adjustment of the inclination angle of the opposed surface 61A with respect to the conveyance direction D11 results in failure.

For example, the control portion 9 causes the operation display portion 8 to display a message indicating that the adjustment of the inclination angle of the opposed surface 61A with respect to the conveyance direction D11 results in failure.

In this way, the image forming apparatus 100 includes the angle changing portion 63 that changes the inclination angle of the opposed surface 61A with respect to the conveyance direction D11. This makes it possible to prevent the attitude of the correcting portion 61 by using the angle changing portion 63 from being inclined with respect to the conveyance direction D11.

In addition, in the image forming apparatus 100, the outer shape of the sheet SH1 that has passed through the correcting portion 61 is read, the inclination angle of the side end of the sheet SH1 that has passed through the correcting portion 61 with respect to the conveyance direction D11 is acquired on the basis of a result of the reading of the outer shape of the sheet SH1, and the inclination angle of the opposed surface 61A with respect to the conveyance direction D11 is adjusted on the basis of a result of the acquisition of the inclination angle. This makes it possible to automatically adjust the inclination angle of the opposed surface 61A with respect to the conveyance direction D11.

In addition, in the image forming apparatus 100, the inclination angle of the side end of the sheet SH1 that has passed through the correcting portion 61 in the first direction D21 (see FIG. 3) with respect to the conveyance direction D11 is acquired on the basis of a result of the reading of the outer shape of the sheet SH1. This makes it possible to avoid a decrease in the accuracy of adjusting the inclination angle of the opposed surface 61A with respect to the conveyance direction D11 in a case where both side ends of the sheet SH1 are not parallel in comparison with a configuration in which the inclination angle of the side end of the sheet SH1 that has passed through the correcting portion 61 in the direction opposite to the first direction D21 with respect to the conveyance direction D11 is acquired.

It is to be noted that the processes of step S12, step S13, and step S16 in the inclination angle adjustment process may be executed whenever, in a case where the image formation process of forming an image on the sheet SH1 is executed, a predetermined number sheets SH1 on each of which an image is formed are conveyed.

### [Supplementary Notes of Invention]

The gist of the invention extracted from the embodiment described above will be supplementarily noted below. It is to be noted that the respective configurations and the respective processing functions described in the following supplementary notes can be sorted out and used in any combination.

### <Supplementary Note 1>

A sheet conveying device including:
a first conveying portion configured to convey a sheet;
a correcting portion provided on an upstream side of the first conveying portion in a conveyance direction of the sheet by the first conveying portion, the correcting portion having an opposed surface that is opposed to a side end of the sheet in a first direction orthogonal to the conveyance direction;
a second conveying portion provided on an upstream side of the correcting portion in the conveyance direction, the second conveying portion being configured to convey the sheet in a second direction toward the opposed surface; and an angle changing portion configured to change an inclination angle of the opposed surface with respect to the conveyance direction.

### <Supplementary Note 2>

An image forming apparatus including:
the sheet conveying device according to Supplementary Note 1; and
an image forming portion configured to form an image on the sheet conveyed by the first conveying portion.

### <Supplementary Note 3>

The image forming apparatus according to Supplementary Note 2, including:
a reading processing portion configured to read an outer shape of the sheet having passed through the correcting portion;
an acquisition processing portion configured to acquire an inclination angle of a side end of the sheet with respect to the conveyance direction on the basis of a result of reading by the reading processing portion, the sheet having passed through the correcting portion; and
an adjustment processing portion configured to adjust the inclination angle of the opposed surface with respect to the conveyance direction on the basis of a result of acquisition by the acquisition processing portion.

### <Supplementary Note 4>

The image forming apparatus according to Supplementary Note 3, in which the acquisition processing portion acquires an inclination angle of the side end of the sheet in the first direction with respect to the conveyance direction on the basis of the result of the reading by the reading processing portion, the sheet having passed through the correcting portion.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A sheet conveying device comprising:
a first conveying portion configured to convey a sheet;
a correcting portion provided on an upstream side of the first conveying portion in a conveyance direction of the sheet by the first conveying portion, the correcting portion having an opposed surface that is opposed to a side end of the sheet in a first direction orthogonal to the conveyance direction;
a second conveying portion provided on an upstream side of the correcting portion in the conveyance direction, the second conveying portion being configured to convey the sheet in a second direction toward the opposed surface; and
an angle changing portion configured to change an inclination angle of the opposed surface with respect to the conveyance direction.

2. An image forming apparatus comprising:
the sheet conveying device according to claim 1; and
an image forming portion configured to form an image on the sheet conveyed by the first conveying portion.

3. The image forming apparatus according to claim 2, comprising:
a reading processing portion configured to read an outer shape of the sheet having passed through the correcting portion;
an acquisition processing portion configured to acquire an inclination angle of a side end of the sheet with respect to the conveyance direction on a basis of a result of reading by the reading processing portion, the sheet having passed through the correcting portion; and
an adjustment processing portion configured to adjust the inclination angle of the opposed surface with respect to the conveyance direction on a basis of a result of acquisition by the acquisition processing portion.

4. The image forming apparatus according to claim 3, wherein the acquisition processing portion acquires an inclination angle of the side end of the sheet in the first direction with respect to the conveyance direction on the basis of the result of the reading by the reading processing portion, the sheet having passed through the correcting portion.
